(19) United States
(12) Patent Application Publication
(10) Pub. No.: US 2026/0183687 A1
(43) Pub. Date: Jul. 2, 2026

(54) FILTER ASSEMBLY

(71) Applicant: KYUNGDONG NAVIEN CO., LTD., Gyeonggi-do (KR)

(72) Inventors: Min Seop OH, Seoul (KR); Jong Kil KIM, Seoul (KR)

(73) Assignee: KYUNGDONG NAVIEN CO., LTD., Gyeonggi-do (KR)

(21) Appl. No.: 19/437,674

(22) Filed: Dec. 31, 2025

(30) Foreign Application Priority Data
Dec. 31, 2024 (KR) 10-2024-0202603
Apr. 8, 2025 (KR) 10-2025-0045109

(51) Int. Cl. B01D 35/30

(52) U.S. Cl. CPC B01D 35/30; B01D 2201/30; B01D 2201/40

(57) ABSTRACT

Disclosed is a filter assembly including a filter module, and a pocket module configured to accommodate therein the filter module, in which the pocket module includes a pocket body region having an accommodation space S, and a pocket fixing region provided at one side of the pocket body region, in which the filter module includes a filter body region configured to be accommodated in the accommodation space S, and a filter concave-convex region provided on an outer peripheral surface of one side of the filter body region and configured to be coupled to the pocket fixing region, and in which the pocket fixing region includes a button member configured to be movable in a first width direction W1, a plate member configured to be movable by the button member in a direction intersecting the outward longitudinal direction A1 and having a hole H configured to connect the accommodation space S and the outside, and a spring member configured to press the plate member.

### CROSS-REFERENCE TO RELATED APPLICATION

This application claims priority to and the benefit of Korean Patent Application No. 10-2024-0202603 filed in the Korean Intellectual Property Office on Dec. 31, 2024, and Korean Patent Application No. 10-2025-0045109 filed in the Korean Intellectual Property Office on Apr. 8, 2025, the entire contents of which are incorporated herein by reference.

### TECHNICAL FIELD

The present disclosure relates to a filter assembly, and more particularly, to a filter assembly capable of filtering water.

### BACKGROUND ART

In general, a water purifier refers to a device for filtering water. The water purifier serves to remove foreign substances, heavy metal, and the like contained in raw water by allowing the raw water to pass through a filtration filter. Such a water purifier may be provided with a pre-treatment filter for filtering relatively large particles or residual chlorine in the raw water, a reverse osmosis (RO) filter for filtering foreign substances such as heavy metal, and a post carbon filter for improving a taste of water.

The filter needs to be periodically replaced. However, in the related art, the filter may be replaced only in a state in which the filter and a pocket in the water purifier are positioned at relatively specific positions, which causes a problem in that it is not easy to perform processes of assembling and replacing the filter.

### SUMMARY

The present disclosure has been made in an effort to enable a user to easily assemble and replace a filter in a water purifier.

In order to achieve the above-mentioned object, one aspect of the present disclosure provides a filter assembly including: a filter module configured to filter raw water in the filter module; and a pocket module configured to accommodate therein the filter module, in which the pocket module includes: a pocket body region having an accommodation space S configured to communicate with the outside through one side of the pocket body region based on an outward longitudinal direction A1; and a pocket fixing region provided at one side of the pocket body region based on the outward longitudinal direction A1, in which the filter module includes: a filter body region configured to be accommodated in the accommodation space S; and a filter concave-convex region provided on an outer peripheral surface of one side of the filter body region based on the outward longitudinal direction A1 and configured to be coupled to the pocket fixing region, and in which the pocket fixing region includes: a button member configured to be movable in a first width direction W1 intersecting the outward longitudinal direction A1; a plate member configured to interfere with the button member, configured to be movable by the button member in a direction intersecting the outward longitudinal direction A1, and having a hole H configured to connect the accommodation space S and the outside; and a spring member configured to press the plate member toward the hole H.

The plate member may include: a first plate member configured to form one portion of an inner surface of the plate member that defines the hole H; and a second plate member configured to form the other portion of the inner surface of the plate member that defines the hole H.

First-first inclined surfaces, which extend to be inclined at a predetermined angle with respect to the first width direction W1, may be respectively formed on i) a surface of the first plate member provided to be in contact with the button member and ii) a surface of the second plate member provided to be in contact with the button member.

The spring member may be provided between an inner surface of the pocket body region and the plate member, and a second width direction W2, which is a direction in which the inner surface of the pocket body region and the plate member face each other with the spring member interposed between, may intersect the first width direction W1.

The first-first inclined surface extends to be inclined at a predetermined angle with respect to the second width direction W2 based on a cross-section obtained by cutting the first-first inclined surface in a direction perpendicular to the outward longitudinal direction A1.

An inner surface of the first plate member or an inner surface of the second plate member may include a first-second inclined surface positioned to be directed outward in the outward longitudinal direction A1.

The filter concave-convex region may include a second inclined surface formed in a region corresponding to the first-second inclined surface, the second inclined surface being positioned to be directed outward in the outward longitudinal direction A1.

The filter concave-convex region may further include a first recessed surface provided to be spaced apart from the second inclined surface in the outward longitudinal direction A1 and having a shape recessed inward.

The filter concave-convex region may further include a second recessed surface provided to be spaced apart from the first recessed surface in the outward longitudinal direction A1 and having a shape recessed inward.

The pocket module may further include a pop-up region provided to face the filter body region and configured to press the filter module in the outward longitudinal direction A1 in the state in which the filter module is accommodated in the accommodation space S.

The pop-up region may include: a pop-up spring member accommodated at one side of the accommodation space S in the pocket body region; and a pop-up pressing member provided at one side of the pop-up spring member, and the pop-up spring member and the filter body region may be provided to face each other in the outward longitudinal direction A1 with the pop-up pressing member interposed therebetween.

The filter module may further include a bonding member attached to an outer surface of the filter body region based on the outward longitudinal direction A1, and a surface of the bonding member, which faces the filter body region, may include: an attachment surface having a bonding material applied thereon and attached to the filter body region; and a non-attachment surface provided at one side of the attachment surface and spaced apart from the filter body region.

The button member may include a button extension region including a shape protruding toward the filter concave-convex region, and the button extension region may be provided to face the second inclined surface of the filter concave-convex region in the state in which the filter module is accommodated in the pocket module.

A region of the button extension region, which faces the second inclined surface, may have a shape corresponding to the second inclined surface.

According to the present disclosure, the user may easily assemble and replace the filter in the water purifier.

### BRIEF DESCRIPTION OF THE DRAWINGS

FIG. 1 is a perspective view illustrating a filter assembly according to the present disclosure.

FIG. 2 is an exploded perspective view illustrating a filter module and a pocket module of the filter assembly according to the present disclosure.

FIG. 3 is a view illustrating a state made before the filter module is fixedly coupled to the pocket module in the filter assembly according to the present disclosure.

FIG. 4 is an enlarged view illustrating a pop-up region in the state in FIG. 3.

FIG. 5 is an enlarged view illustrating a filter concave-convex region and a pocket fixing region in the state in FIG. 3.

FIG. 6 is a view illustrating a state in which the filter module is fixedly coupled to the pocket module in the filter assembly according to the present disclosure.

FIG. 7 is an enlarged view illustrating the pop-up region in the state in FIG. 6.

FIG. 8 is an enlarged view illustrating the filter concave-convex region and the pocket fixing region in the state in FIG. 6.

FIG. 9 is a view illustrating a state in which a button member is pressed in the pocket fixing region of the filter assembly according to the present disclosure.

FIG. 10 is a view illustrating a state in which the button member is not pressed in the pocket fixing region of the filter assembly according to the present disclosure.

FIG. 11 is a view for explaining a shape of the filter concave-convex region of the filter assembly according to the present disclosure.

FIG. 12 is a second perspective view of the filter assembly according to the present disclosure.

FIG. 13 is a cross-sectional view of the filter module provided in the filter assembly according to the present disclosure.

FIG. 14 is a view illustrating an inlet region, an outlet region, and a partition wall region provided in the filter module according to the present disclosure.

FIG. 15 is a view illustrating another example of the inlet region, the outlet region, and the partition wall region provided in the filter module according to the present disclosure.

FIG. 16 is a cross-sectional view illustrating a state in which the filter module is inserted and coupled into the pocket module according to the present disclosure.

FIG. 17 is an enlarged cross-sectional view illustrating the button member of the pocket module according to the present disclosure and surrounding components thereof and illustrating a state made before the button member is pressed.

FIG. 18 is an enlarged cross-sectional view illustrating the button member of the pocket module according to the present disclosure and surrounding components thereof and illustrating a state made after the button member is pressed.

### DETAILED DESCRIPTION

Hereinafter, a filter assembly according to the present disclosure will be described with reference to the drawings.

The filter assembly according to the present disclosure may be mounted in and used for a water purifier for purifying raw water. The filter assembly according to the present disclosure may be applied to an RO filter configured to filter foreign substances or a carbon filter configured to improve a taste of water.

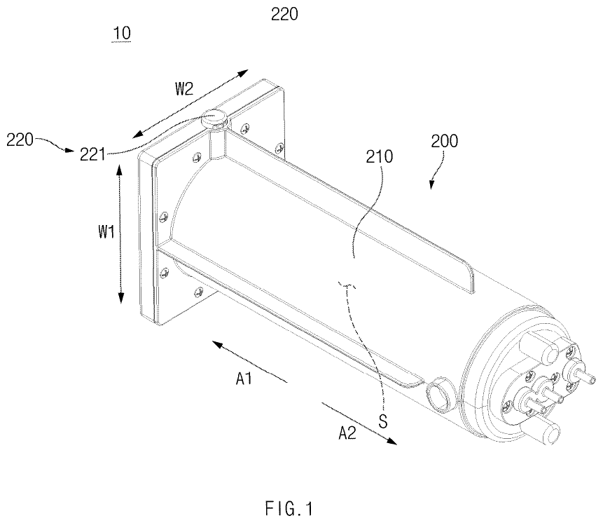

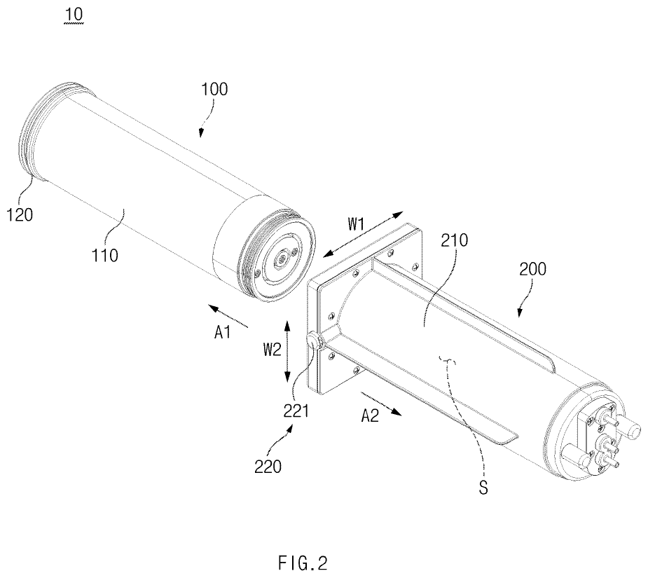

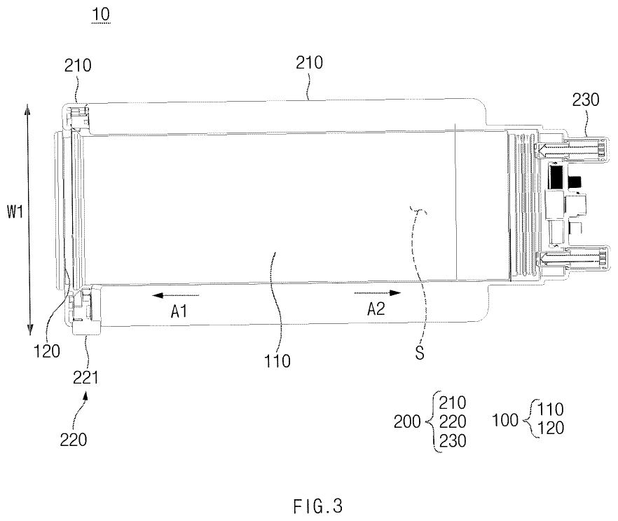

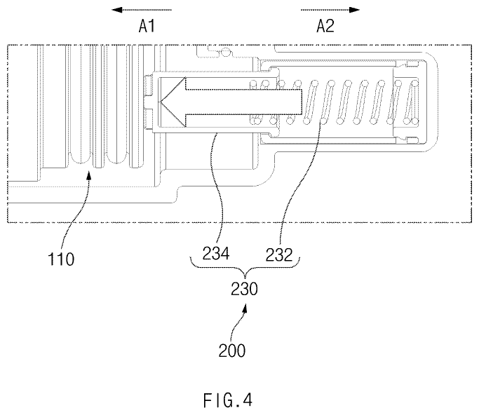

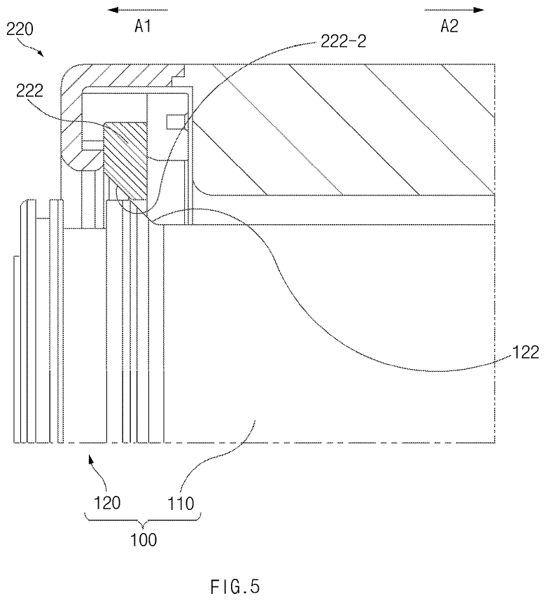

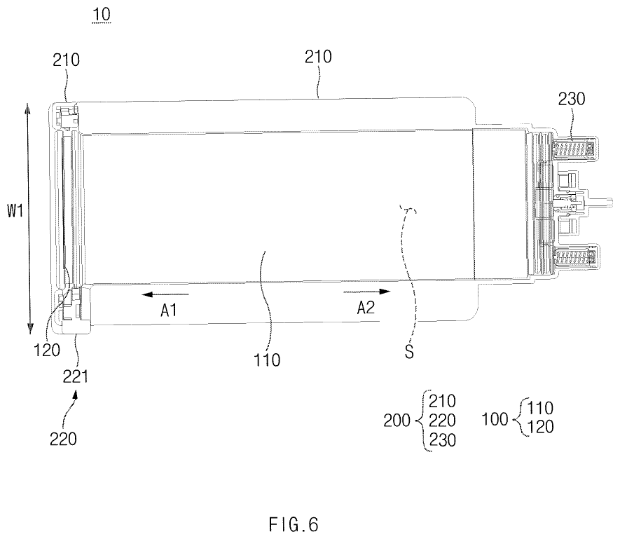

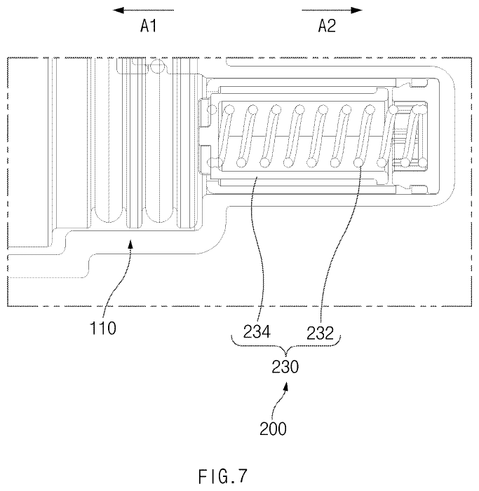

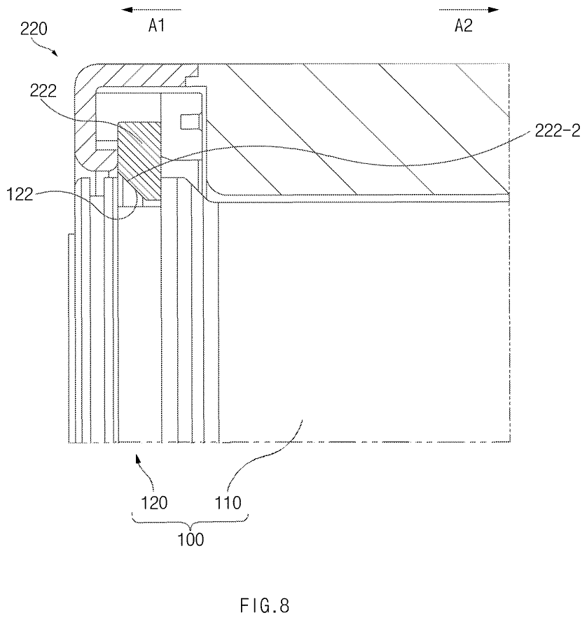

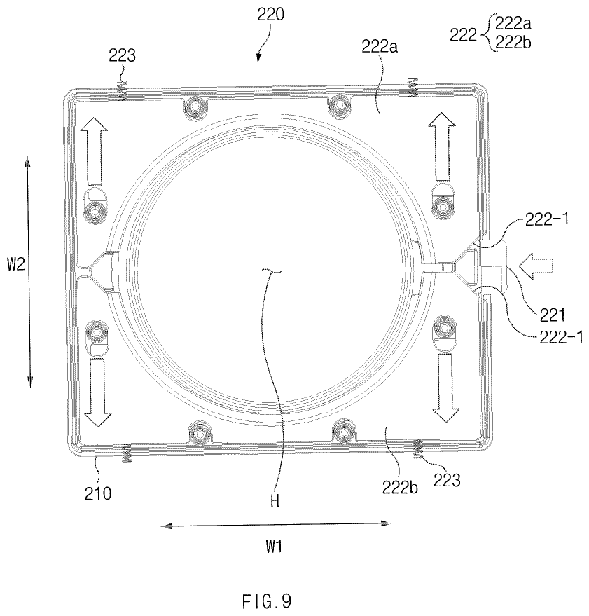

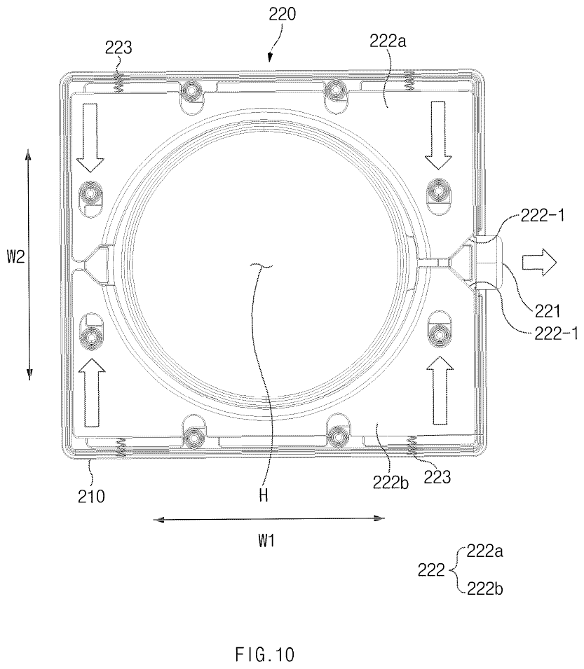

FIG. 1 is a perspective view illustrating the filter assembly according to the present disclosure, and FIG. 2 is an exploded perspective view illustrating a filter module and a pocket module of the filter assembly according to the present disclosure. FIG. 3 is a view illustrating a state made before the filter module is fixedly coupled to the pocket module in the filter assembly according to the present disclosure, and FIG. 4 is an enlarged view illustrating a pop-up region in the state in FIG. 3. FIG. 5 is an enlarged view illustrating a filter concave-convex region and a pocket fixing region in the state in FIG. 3, and FIG. 6 is a view illustrating a state in which the filter module is fixedly coupled to the pocket module in the filter assembly according to the present disclosure. FIG. 7 is an enlarged view illustrating the pop-up region in the state in FIG. 6, and FIG. 8 is an enlarged view illustrating the filter concave-convex region and the pocket fixing region in the state in FIG. 6. FIG. 9 is a view illustrating a state in which a button member is pressed in the pocket fixing region of the filter assembly according to the present disclosure, and FIG. 10 is a view illustrating a state in which the button member is not pressed in the pocket fixing region of the filter assembly according to the present disclosure.

A filter assembly 10 according to the present disclosure may include a filter module 100 configured to filter raw water in the filter module 100, and a pocket module 200 configured to accommodate therein the filter module 100. More specifically, the filter module 100 may be provided to be attachable to or detachable from the pocket module 200. As described below, according to the present disclosure, the filter module 100 may not only be easily detached from the pocket module 200, but also be easily assembled to the pocket module 200.

As illustrated in FIGS. 1 to 3, the pocket module 200 may include a pocket body region 210 having an accommodation space S configured to communicate with the outside through one side of the pocket body region 210 based on an outward longitudinal direction A1 of the filter assembly 10, and a pocket fixing region 220 provided at one side of the pocket body region 210 based on the outward longitudinal direction A1. Meanwhile, in the present specification, in the longitudinal direction of the filter assembly, a direction (a leftward direction based on FIG. 2) in which the filter module 100 is detached from the pocket module 200 is defined as the outward longitudinal direction A1, and a direction (a rightward direction based on FIG. 2) in which the filter module 100 is assembled to the pocket module 200 is defined as an inward longitudinal direction A2.

Meanwhile, the filter module 100 may include a filter body region 110 configured to be accommodated in the accommodation space S, and a filter concave-convex region 120 provided on an outer peripheral surface of one side of the filter body region 110 based on the outward longitudinal direction A1 and configured to be coupled to the pocket fixing region 220. As described below, based on a state in which the filter module 100 and the pocket module 200 are assembled, the filter concave-convex region 120 may be coupled to the pocket fixing region 220, and the filter module 100 may be prevented from being spaced apart from the pocket fixing region 220 in the outward longitudinal direction A1.

In addition, as illustrated in FIGS. 3, 4, 6, and 7, the pocket module 200 may further include a pop-up region 230 provided to face the filter body region 110 and configured to press the filter module 100 in the outward longitudinal direction A1 in the state in which the filter module 100 is accommodated in the accommodation space S. The pop-up region 230 may press the filter module 100 in the outward longitudinal direction A1 in the state in which the filter module 100 is assembled to the pocket module 200. As described below, when the filter concave-convex region 120 and the pocket fixing region 220 are physically uncoupled, the pop-up region 230 presses the filter module 100 in the outward longitudinal direction A1, such that the filter module 100 may be smoothly separated from the pocket module 200.

More specifically, the pop-up region 230 may include a pop-up spring member 232 accommodated at one side of the accommodation space S in the pocket body region 210, and a pop-up pressing member 234 provided at one side of the pop-up spring member 232. More specifically, the pop-up pressing member 234 may be provided to face the filter concave-convex region 120 with the filter body region 110 interposed therebetween. The pop-up spring member 232 and the filter body region 110 may be provided to face each other in the outward longitudinal direction A1 with the pop-up pressing member 234 interposed therebetween. Therefore, the pop-up spring member 232 may press the filter body region 110 in the outward longitudinal direction A1 through the pop-up pressing member 234.

Meanwhile, as illustrated in FIGS. 9 and 10, the pocket fixing region 220 may include a button member 221 configured to be movable in a first width direction W1 perpendicularly intersecting the outward longitudinal direction A1, and a plate member 222 configured to interfere with the button member 221, configured to be movable by the button member 221 in a direction intersecting the outward longitudinal direction A1, and having a hole H configured to connect the accommodation space S and the outside. More specifically, in the state in which the filter module 100 and the pocket module 200 are assembled (see FIG. 8), the filter concave-convex region 120 and the plate member 222 interfere with each other, such that the filter concave-convex region 120 and the pocket fixing region 220 may be fixed.

In addition, according to the present disclosure, the pocket fixing region 220 may further include a configuration configured to press the plate member 222. More specifically, the pocket fixing region 220 may further include spring members 223 configured to press the plate member 222 toward the hole H. The spring member 223 may be configured to press the plate member 222, thereby allowing the plate member 222 and the filter concave-convex region 120 to continue to interfere with each other. Therefore, according to the present disclosure, the state in which the filter module 100 and the pocket module 200 are assembled to each other may be stably maintained.

Meanwhile, according to one example of the present disclosure, the above-mentioned plate member 222 may include a plurality of components. More specifically, the plate member 222 may include a first plate member 222a configured to form one portion of an inner surface of the plate member 222 that defines the hole H, and a second plate member 222b configured to form the other portion of the inner surface of the plate member 222 that defines the hole H. Particularly, the plate member 222 may include the first plate member 222a and the second plate member 222b. The first plate member 222a and the second plate member 222b may have shapes symmetrical to each other.

Meanwhile, inclined surfaces may be formed in regions in which the first plate member 222a and the second plate member 222b come into contact with the button member 221. More specifically, as illustrated in FIGS. 9 and 10, first-first inclined surfaces 222-1, which extend to be inclined at a predetermined angle with respect to the first width direction W1, may be respectively formed on i) a surface of the first plate member 222a provided to be in contact with the button member 221 and ii) a surface of the second plate member 222b provided to be in contact with the button member 221.

In this case, the spring member 223 may be provided between an inner surface of the pocket body region 210 and the plate member 222, and a second width direction W2, which is a direction in which the inner surface of the pocket body region 210 and the plate member 222 face each other with the spring member 223 interposed therebetween, may perpendicularly intersect the first width direction W1. In this case, as illustrated in FIGS. 9 and 10, based on a cross-section obtained by cutting the first-first inclined surface 222-1 in a direction perpendicular to the outward longitudinal direction A1, the first-first inclined surface 222-1 may extend to be inclined at a predetermined angle with respect to the second width direction W2.

An operational principle of the pocket fixing region 220 will be described below based on the above-mentioned description. As illustrated in FIG. 9, when the button member 221 is pressed inward in the first width direction W1, the first and second plate members 222a and 222b, which are in contact with the button member 221, are pushed outward in the second width direction W2 by means of the first-first inclined surfaces 222-1, which intersect the first width direction W1, the second width direction W2, and the longitudinal directions A1 and A2, such that the hole H is expanded. In case that the hole H is expanded, the filter module 100 may be accommodated in the accommodation space S through the hole H. In this case, the spring members 223 are compressed by the plate member 222 pushed outward in the second width direction W2.

Alternatively, when the hole H is expanded as the button member 221 is pressed inward in the first width direction W1 in the state in which the filter module 100 is assembled to the pocket module 200, the filter module 100, which is pressed by the pop-up region 230 at ordinary times, may be separated outward from the pocket module 200.

Thereafter, as illustrated in FIG. 10, when a force applied to the button member 221 is eliminated, the first plate member 222a and the second plate member 222b are moved inward in the second width direction W2 by a force applied to the plate member 222 by the compressed spring member 223, such that the hole H is contracted. Therefore, when the hole H is contracted, the plate member 222 and the filter concave-convex region 120 may interfere with each other, thereby preventing the filter module 100 from separating from the pocket module 200 in the outward longitudinal direction A1.

With continued reference to FIGS. 5 and 8, an inner surface of the first plate member 222a or an inner surface of the second plate member 222b may further include a first-second inclined surface 222-2 positioned to be directed widthwise outward in the outward longitudinal direction A1. The first-second inclined surface 222-2 may be configured to allow the filter concave-convex region 120 to smoothly enter while pushing the plate member 222 outward when the filter module 100 is inserted into the accommodation space S of the pocket module 200. That is, according to the present disclosure, even though a user only performs an operation of simply pushing the filter module 100 into the pocket module 200 without manipulating the button member 221, the hole H defined by the plate member 222 may be expanded, such that the filter module 100 may be smoothly inserted into the pocket module 200.

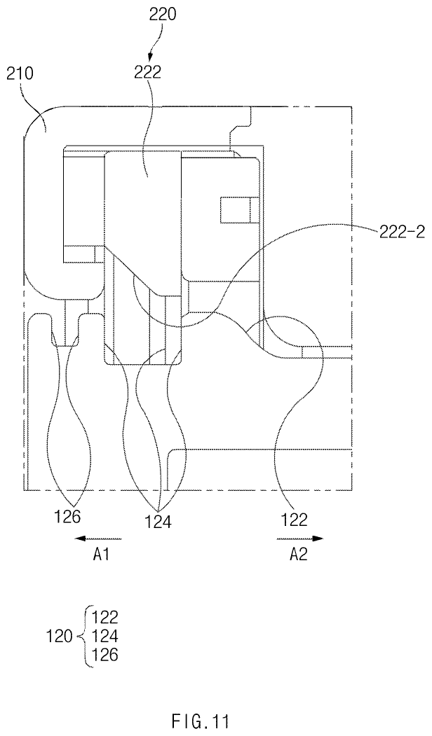

FIG. 11 is a view for explaining a shape of the filter concave-convex region of the filter assembly according to the present disclosure.

As illustrated in FIG. 11, the filter concave-convex region 120 may include a second inclined surface 122 formed in a region corresponding to the first-second inclined surface 222-2, the second inclined surface 122 being positioned to be directed outward in the outward longitudinal direction A1. More specifically, the second inclined surface 122 may be configured to come into contact with the first-second inclined surface 222-2 during the process in which the filter module 100 is inserted into the pocket module 200. Therefore, during the process in which the filter module 100 is inserted into the pocket module 200, the second inclined surface 122 may push the first-second inclined surface 222-2 outward. More particularly, an angle defined between the second inclined surface 122 and the longitudinal directions A1 and A2 may correspond to or be equal to an angle defined between the first-second inclined surface 222-2 and the longitudinal directions A1 and A2.

With continued reference to FIG. 11, the filter concave-convex region 120 may further include first recessed surfaces 124 provided to be spaced apart from the second inclined surface 122 in the outward longitudinal direction A1 and having shapes recessed inward. Based on the state in which the filter module 100 and the pocket module 200 are assembled and coupled to each other, the first-second inclined surface 222-2 of the plate member 222 may be accommodated in a space defined by the first recessed surfaces 124 (see FIG. 8).

Meanwhile, as illustrated in FIG. 11, according to the present disclosure, the filter concave-convex region 120 may further include second recessed surfaces 126 provided to be spaced apart from the first recessed surface 124 in the outward longitudinal direction A1 and having shapes recessed inward. The second recessed surfaces 126 may be configured to provide a space into which another external tool (e.g., a screw driver) may be inserted in an emergency state in which the filter module 100 cannot be separated from the pocket module 200 by the operation of pressing the button member 221. More specifically, the second recessed surfaces 126 may be formed at an end of the filter concave-convex region 120 based on the outward longitudinal direction A1.

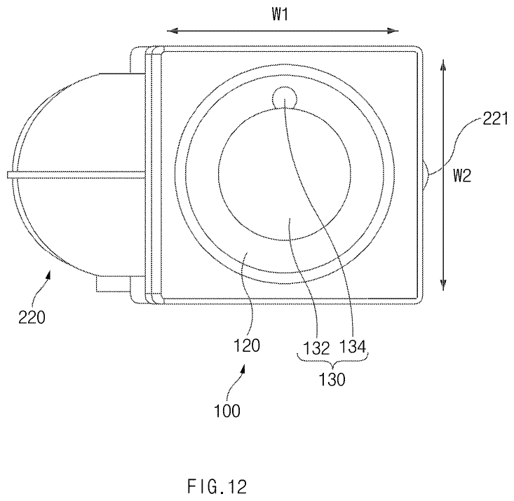

FIG. 12 is a second perspective view of the filter assembly according to the present disclosure.

Meanwhile, as illustrated in FIG. 12, the filter module 100 may further include a bonding member 130 attached to an outer surface of the filter body region 110 based on the outward longitudinal direction A1. Similar to the second recessed surfaces 126, the bonding member 130 may also be configured to provide a region in which the user may hold and pull the filter module 100 in an emergency state in which the filter module 100 cannot be separated from the pocket module 200. To this end, a surface of the bonding member 130, which faces the filter body region 110, may include an attachment surface 132 having a bonding material applied thereon and attached to the filter body region 110, and a non-attachment surface 134 provided at one side of the attachment surface 132 and spaced apart from the filter body region 110. More specifically, the non-attachment surface 134 may not be attached to the filter body region 110. Therefore, the non-attachment surface 134 may be a region configured to be gripped by the user. Therefore, in the state in which the user grips the non-attachment surface 134, the user may pull the filter module 100 in the outward longitudinal direction A1.

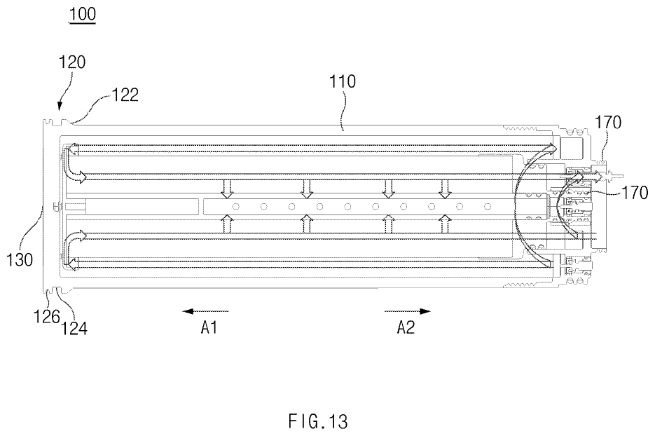

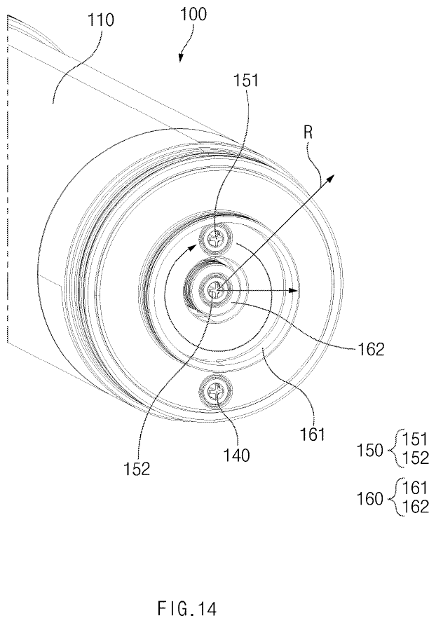

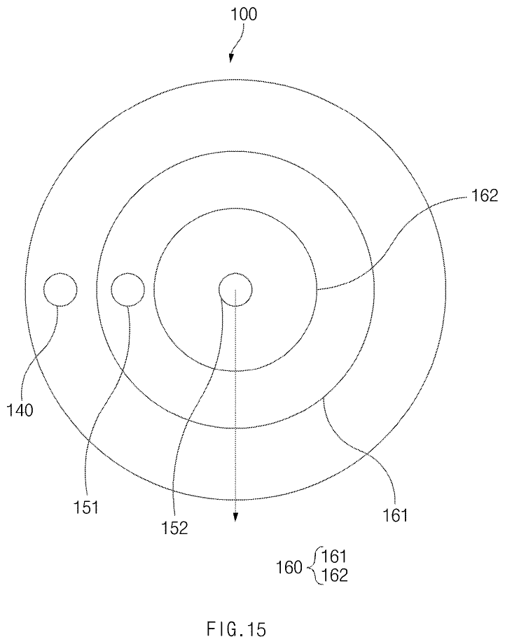

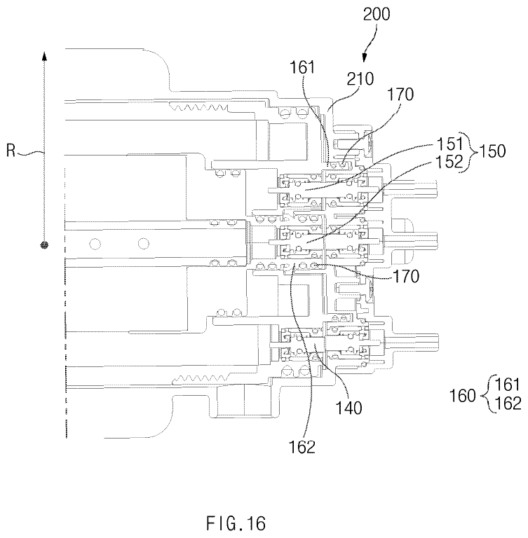

FIG. 13 is a cross-sectional view of the filter module provided in the filter assembly according to the present disclosure, and FIG. 14 is a view illustrating an inlet region, an outlet region, and a partition wall region provided in the filter module according to the present disclosure. FIG. 15 is a view illustrating another example of the inlet region, the outlet region, and the partition wall region provided in the filter module according to the present disclosure, and FIG. 16 is a cross-sectional view illustrating a state in which the filter module is inserted and coupled into the pocket module according to the present disclosure.

Meanwhile, according to the present disclosure, the filter body region 110 may be additionally provided with a configuration configured to provide a route through which raw water intended to be purified is introduced into the filter module 100 and the purified water is discharged.

More specifically, as illustrated in FIGS. 13 to 15, the filter module 100 may further include an inlet region 140 formed on an outer surface of the filter body region 110 based on the inward longitudinal direction A2 that is a direction opposite to the outward longitudinal direction A1, and an outlet region 150 formed on an outer surface of the filter body region 110 based on the inward longitudinal direction A2. The inlet region 140 may provide a route through which a fluid (e.g., raw water) is supplied into the filter module 100, and the outlet region 150 may provide a route through which a fluid (e.g., purified water, wastewater) is discharged to the outside from the inside of the filter module 100. In this case, according to the present disclosure, the inlet region 140 and the outlet region 150 may be provided to be spaced apart from each other in a radial direction R of the filter module 100.

In addition, the filter module 100 may further include a partition wall region 160 provided between the inlet region 140 and the outlet region 150 in the radial direction R perpendicular to the longitudinal directions A1 and A2 and protruding from the filter body region 110 in the inward longitudinal direction A2. The partition wall region 160 may be configured to prevent the fluid, which is introduced into the filter module 100 through the inlet region 140, and the fluid, which is discharged from the filter module 100 through the outlet region 150, from being mixed with each other. In order to achieve the above-mentioned object, a cross-section obtained by cutting the partition wall region 160 in a direction perpendicular to the inward longitudinal direction A2 may have a shape of a closed curve. More specifically, the partition wall region 160 may have a cross-sectional shape of a circle.

Meanwhile, for example, the inlet region 140 may be provided outward of the outlet region 150 based on the radial direction R. In addition, the outlet region 150 may be provided as a single outlet region 150. Alternatively, the outlet region 150 may be provided as a plurality of outlet regions 150. More specifically, the outlet region 150 may include a first outlet region 151 provided inward of the inlet region 140 based on the radial direction R, and a second outlet region 152 provided inward of the first outlet region 151 based on the radial direction R. In case that the outlet region 150 is provided as a single outlet region 150, the filter assembly may be applied to a carbon filter. In case that the outlet region 150 includes the first outlet region 151 and the second outlet region 152, the filter assembly may be applied to an RO filter. For example, the first outlet region 151 may be configured to discharge the fluid (e.g., wastewater), which contains foreign substances, to the outside, and the second outlet region 152 may be configured to discharge the fluid (e.g., purified water), from which foreign substances are removed, to the outside.

Meanwhile, in case that the outlet region 150 includes the first outlet region and the second outlet region, the partition wall region 160 may be provided as a plurality of partition wall regions 160 corresponding to the first outlet region and the second outlet region. More specifically, as illustrated in FIG. 14, the partition wall region 160 may include a first partition wall region 161 provided between the inlet region 140 and the first outlet region 151 in the radial direction R, and a second partition wall region 162 provided between the first outlet region 151 and the second outlet region 152 in the radial direction R. The first partition wall region 161 and the second partition wall region 162 may also each have a cross-sectional shape with a shape of a closed curve. More particularly, the first partition wall region 161 and the second partition wall region 162 may have cross-sectional shapes of concentric circles. Meanwhile, for example, the second outlet region 152 may be formed at a center of the filter body region 110 based on the radial direction R.

With continued reference to FIGS. 14 and 15, the inlet region 140, the first outlet region 151, and the second outlet region 152 may be provided on a straight line. For example, as illustrated in FIG. 14, the inlet region 140 and the first outlet region 151 may be provided to face each other with the second outlet region 152 interposed therebetween. However, in another example, as illustrated in FIG. 15, the inlet region 140 and the second outlet region 152 may be provided to face each other with the first outlet region 151 interposed therebetween.

Meanwhile, with reference to FIGS. 14 to 16, the partition wall region 160 may be inserted into the pocket body region 210. In this case, the configuration in which the partition wall region 160 is inserted into the pocket body region 210 may refer to a configuration in which a concave-convex region may be formed on the inner surface of the pocket body region 210 directed toward the partition wall region 160, and the partition wall region 160 may be inserted into the above-mentioned concave-convex region and prevented from moving in the radial direction R.

In addition, as illustrated in FIG. 16, according to the present disclosure, the filter module 100 may further include O-ring members 170 provided on surfaces of the partition wall region 160 inserted into the pocket body region 210 and facing the pocket body region 210 in the radial direction R. The O-ring member 170 may be configured to ensure sealability in a region in which the partition wall region 160 and the pocket body region 210 are coupled. In this case, for example, the O-ring member 170 may be inserted into the partition wall region 160. The O-ring member 170 may be provided as a plurality of O-ring members 170. More specifically, all the plurality of O-ring members 170, which are disposed in a region in which the partition wall region 160 and the pocket body region 210 face each other in the radial direction R, may be inserted only into the partition wall region 160 without being inserted into the pocket body region 210.

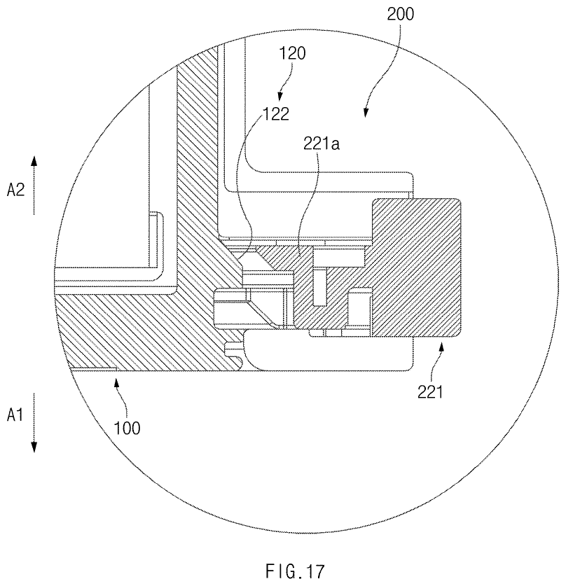

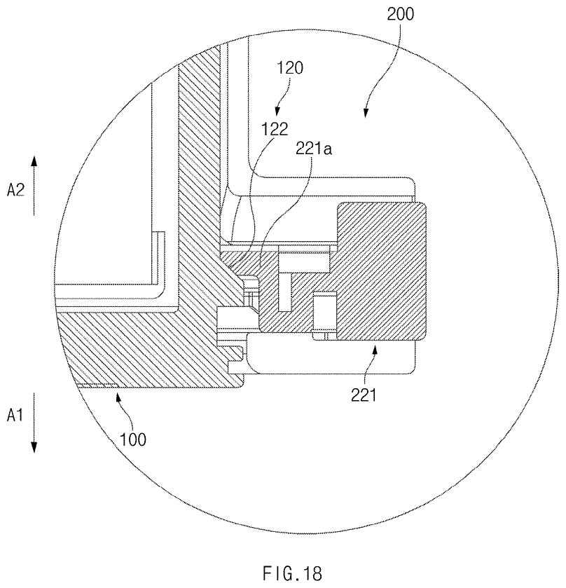

FIG. 17 is an enlarged cross-sectional view illustrating the button member of the pocket module according to the present disclosure and surrounding components thereof and illustrating a state made before the button member is pressed, and FIG. 18 is an enlarged cross-sectional view illustrating the button member of the pocket module according to the present disclosure and surrounding components thereof and illustrating a state made after the button member is pressed.

The filter assembly according to the present disclosure may further include a structure capable of ensuring that the filter module 100 is separated from the pocket module 200 by a manual manipulation even in case that the above-mentioned pop-up region 230 cannot exhibit the function thereof.

More specifically, according to the present disclosure, the button member 221 is spaced apart from the filter concave-convex region 120 before the button member 221 is pressed. In case that the button member 221 is pressed, a part of the button member 221 may interfere with the filter concave-convex region 120. That is, as illustrated in FIGS. 17 and 18, the button member 221 may include a button extension region 221a including a shape protruding toward the filter concave-convex region 120. For example, the button extension region 221a includes a region extending in the outward longitudinal direction A1 and the inward longitudinal direction A2, such that the button extension region 221a may have a meandering cross-sectional shape.

In this case, in the state in which the filter module 100 is accommodated in the pocket module 200, the button extension region 221a may be provided to face the second inclined surface 122 of the filter concave-convex region 120, and a region of the button extension region 221a, which faces the second inclined surface 122, may have a shape corresponding to the second inclined surface 122. Therefore, according to the present disclosure, the button extension region 221a is spaced apart from the second inclined surface 122 before the button member 221 is pressed (see FIG. 17). When the button member 221 is pressed, the button extension region 221a comes into contact with the second inclined surface 122 and then presses the second inclined surface 122, such that the filter module 100 may be pushed away in the outward longitudinal direction A1 (see FIG. 18).

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A filter assembly comprising:
a filter module configured to filter raw water in the filter module; and
a pocket module configured to accommodate therein the filter module,
wherein the pocket module comprises:
a pocket body region having an accommodation space S configured to communicate with the outside through one side of the pocket body region based on an outward longitudinal direction A1; and
a pocket fixing region provided at one side of the pocket body region based on the outward longitudinal direction A1,
wherein the filter module comprises:
a filter body region configured to be accommodated in the accommodation space S; and
a filter concave-convex region provided on an outer peripheral surface of one side of the filter body region based on the outward longitudinal direction A1 and configured to be coupled to the pocket fixing region, and
wherein the pocket fixing region comprises:
a button member configured to be movable in a first width direction W1 intersecting the outward longitudinal direction A1;
a plate member configured to interfere with the button member, configured to be movable by the button member in a direction intersecting the outward longitudinal direction A1, and having a hole H configured to connect the accommodation space S and the outside; and
a spring member configured to press the plate member toward the hole H.

2. The filter assembly of claim 1, wherein the plate member comprises:
a first plate member configured to form one portion of an inner surface of the plate member that defines the hole H; and
a second plate member configured to form the other portion of the inner surface of the plate member that defines the hole H.

3. The filter assembly of claim 2, wherein first-first inclined surfaces, which extend to be inclined at a predetermined angle with respect to the first width direction W1, are respectively formed on i) a surface of the first plate member provided to be in contact with the button member and ii) a surface of the second plate member provided to be in contact with the button member.

4. The filter assembly of claim 3, wherein the spring member is provided between an inner surface of the pocket body region and the plate member, and a second width direction W2, which is a direction in which the inner surface of the pocket body region and the plate member face each other with the spring member interposed between, intersects the first width direction W1.

5. The filter assembly of claim 4, wherein the first-first inclined surface extends to be inclined at a predetermined angle with respect to the second width direction W2 based on a cross-section obtained by cutting the first-first inclined surface in a direction perpendicular to the outward longitudinal direction A1.

6. The filter assembly of claim 2, wherein an inner surface of the first plate member or an inner surface of the second plate member comprises a first-second inclined surface positioned to be directed outward in the outward longitudinal direction A1.

7. The filter assembly of claim 6, wherein the filter concave-convex region comprises a second inclined surface formed in a region corresponding to the first-second inclined surface, the second inclined surface being positioned to be directed outward in the outward longitudinal direction A1.

8. The filter assembly of claim 7, wherein the filter concave-convex region further comprises a first recessed surface provided to be spaced apart from the second inclined surface in the outward longitudinal direction A1 and having a shape recessed inward.

9. The filter assembly of claim 8, wherein the filter concave-convex region further comprises a second recessed surface provided to be spaced apart from the first recessed surface in the outward longitudinal direction A1 and having a shape recessed inward.

10. The filter assembly of claim 1, wherein the pocket module further comprises a pop-up region provided to face the filter body region and configured to press the filter module in the outward longitudinal direction A1 in the state in which the filter module is accommodated in the accommodation space S.

11. The filter assembly of claim 10, wherein the pop-up region comprises:
a pop-up spring member accommodated at one side of the accommodation space S in the pocket body region; and
a pop-up pressing member provided at one side of the pop-up spring member, and
wherein the pop-up spring member and the filter body region are provided to face each other in the outward longitudinal direction A1 with the pop-up pressing member interposed therebetween.

12. The filter assembly of claim 1, wherein the filter module further comprises a bonding member attached to an outer surface of the filter body region based on the outward longitudinal direction A1, and
wherein a surface of the bonding member, which faces the filter body region, comprises:
an attachment surface having a bonding material applied thereon and attached to the filter body region; and
a non-attachment surface provided at one side of the attachment surface and spaced apart from the filter body region.

13. The filter assembly of claim 7, wherein the button member comprises a button extension region including a shape protruding toward the filter concave-convex region, and
wherein the button extension region is provided to face the second inclined surface of the filter concave-convex region in the state in which the filter module is accommodated in the pocket module.

14. The filter assembly of claim 13, wherein a region of the button extension region, which faces the second inclined surface, has a shape corresponding to the second inclined surface.
